(19) United States
(12) Patent Application Publication
(10) Pub. No.: US 2022/0312742 A1
(43) Pub. Date: Oct. 6, 2022

(54) PET DOG GARMENT STRUCTURE

(71) Applicant: GUANGZHOU CHARM SHINE INTERNATIONAL ECOMMERCE CO., LTD., Panyu (CN)

(72) Inventor: Shangjie LIANG, Panyu (CN)

(21) Appl. No.: 17/700,114

(22) Filed: Mar. 21, 2022

(30) Foreign Application Priority Data
Mar. 30, 2021 (CN) 2021206467179

(51) Int. Cl. A01K 27/00; A01K 13/00

(52) U.S. Cl. CPC A01K 27/002; A01K 13/006

(57) ABSTRACT

A pet garment structure includes a garment body, traction buckles, and a traction belt. The garment body has two foreleg sleeve openings, a collar edge, a distal edge, and at least first and second dorsal edges configured to be fastened to each other about the back of a pet, such that the collar edge and distal edge extends around the pet when the first and second dorsal edges are fastened. The traction buckles are located on proximate the first and second dorsal edges and are configured to connect to a traction rope. The traction buckles are connected by a traction belt wrapped configured to extend around the pet from below when the first and second dorsal edges are fastened such that the garment body extends around the pet with two legs of the pet extending through the foreleg sleeve openings. At least a portion of the traction belt integrally sewn to the garment body

This application claims priority to Chinese Patent Application No. 2021206467179 filed on Mar. 30, 2021, the disclosure of which is incorporated in its entirety by reference herein.

### TECHNICAL FIELD

The present disclosure relates to the technical field of pet supplies, and specifically, to a pet dog garment structure.

### BACKGROUND

With the rise of the pet market, there are more types of pet supplies, such as pet dog garments, pet dog leashes or traction ropes, and the like. Because basic functional leashes and garments have been known, more attention is paid to personalized and comfort designs in such products. Currently, pet dog garments and leash or traction rope assemblies are mostly products with independent functions and used separately. Inconvenience can occur when leash assemblies and pet dog garments are used at the same time. For example, if a traction rope assembly is worn under a garment, then the traction rope assembly may introduce gaps between the pet and the garment. In this case, not only the heat retention properties and comfort are reduced, but also the garment is likely to wear off inside. However, if the traction rope assembly is worn outside the garment, then the comfort is still reduced, and the garment appearance is affected.

The Chinese utility model patent No. CN201718309U discloses a multi-functional pet garment with a structure in which a connecting buckle is disposed on a garment body. Although the pet garment in this structure integrates the connecting buckle with the garment, there are still some problems in use. During traction, the point of force mainly focuses on the connecting buckle. In this case, the garment body is likely to be pulled and moved, which affects the comfort. Because of the concentrated force, the garment body can be torn or disconnected from the connecting buckle, which reduces the service life of the garment body. In addition, the pet dog is likely to break through and come loose from the connecting buckle, causing inconvenience associated with a loose pet.

### SUMMARY

An objective of the present disclosure is to provide a pet dog garment structure which provides comfort, has improved reliability, and does not adversely affect appearance.

To achieve the foregoing objective, the present disclosure adopts the following technical solutions:

A pet dog garment structure is provided, including a garment body having two foreleg sleeve openings corresponding to a fastener on a back of a pet dog, and at least a pair of traction buckles located on two sides of the fastener and configured to connect to a traction rope. The traction buckles on the two sides are connected by a traction belt wrapped around the pet dog from below, and the traction belt is disposed on the garment body.

A beneficial effect of the solution lies in that, force of the traction buckles is dispersed through the traction belt, which prevents the garment body from deformation and even tearing and breaking due to pulling, improving the reliability, safety, and comfort of the structure. In addition, the traction belt is disposed on the garment body. The one-piece structure does not need to be worn separately, which can improve wearing comfort and does not affect appearance of the garment body.

In a preferable solution, the traction belt is integrally sewn on the garment body. Further, the traction belt is integrally sewn in interlining of the garment body. In the foregoing solution, the traction belt is fixed on the garment body, which can prevent the traction belt from loosing and shifting. The traction belt is sewn in the interlining of the garment body, which further improves the wearing comfort.

In a preferable solution, the traction belt is movably disposed in the interlining of the garment body. In the foregoing solution, the comfort is ensured, and the garment body is not affected when the traction belt is being pulled, which can avoid destroying the garment body.

In a preferable solution, at least two traction belts are included. One is located on a front side of forelegs of the pet dog, and the other is located on a rear side of the forelegs of the pet dog. Further, a connecting belt connecting the two traction belts located on the front side and the rear side is further provided between the forelegs of the pet dog. Still further, the traction belts and the connecting belt are webbings of flat structure.

In the foregoing solution, one traction belt is respectively disposed on the front and rear sides of the forelegs of the pet dog, and connected by the connecting belt. In this way, traction can be dispersed evenly around the forelegs of the pet dog. In addition, the webbings of flat structure reduce the tightening feeling, and can further improve the comfort and reliability during traction.

A first embodiment is a pet garment structure that includes a garment body, traction buckles, and a traction belt. The garment body has two foreleg sleeve openings, a collar edge, a distal edge, and at least first and second dorsal edges configured to be fastened to each other about the back of a pet, such that the collar edge and distal edge extends around the pet when the first and second dorsal edges are fastened. The traction buckles are located on proximate the first and second dorsal edges and are configured to connect to a traction rope. The traction buckles are connected by a traction belt wrapped configured to extend around the pet from below when the first and second dorsal edges are fastened such that the garment body extends around the pet with two legs of the pet extending through the foreleg sleeve openings. At least a portion of the traction belt integrally sewn to the garment body.

The above-described features and advantages, as well as others, will become more readily apparent to those of ordinary skill in the art by reference to the following detailed description and accompanying drawings.

### BRIEF DESCRIPTION OF THE DRAWINGS

The present disclosure is further described below in detail with reference to the accompanying drawings and specific embodiments.

FIG. 1 is a perspective view of an overall structure of a pet garment according to an embodiment;

FIG. 2 is a schematic plan view diagram of an internal structure of the pet garment of FIG. 1; and

FIG. 3 is a schematic structural diagram of traction buckles and a traction belt of the pet garment of FIG. 1.

### DETAILED DESCRIPTION

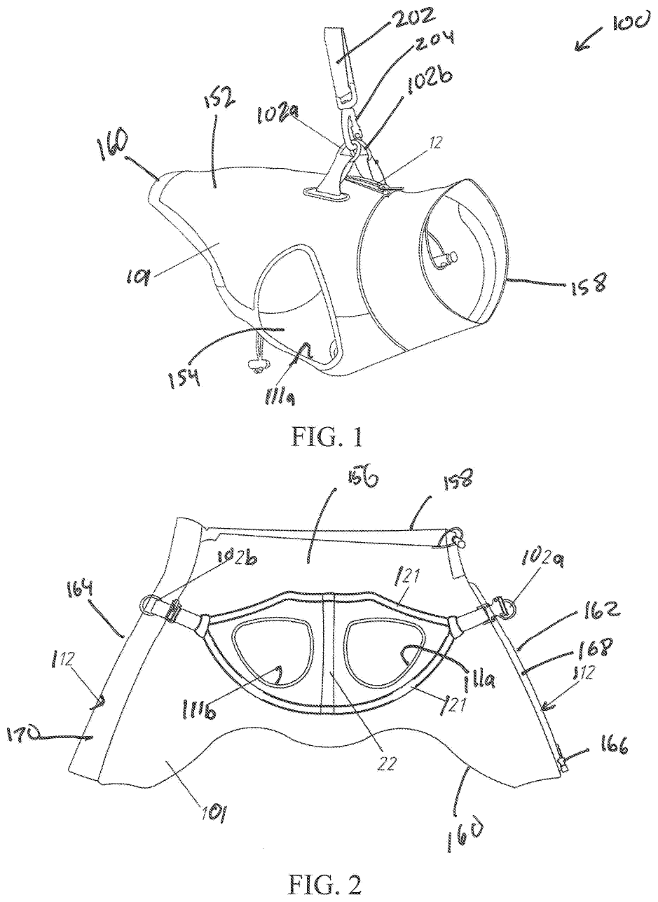

The present disclosure is further described below with reference to the accompanying drawings. FIG. 1 is a perspective view of an overall structure of a pet garment 100 according to an embodiment. In this embodiment, the pet garment 100 is configured for use on a pet dog, but can be adapted to fit other four-legged pets. The pet garment 100 includes a garment body 101, a pair of traction buckles 102a, 102b, and a traction belt 121. The garment body 101 includes an outer layer 152 and an inner layer 154. In a preferred embodiment, the garment body 101 includes an interlining 156 disposed between the outer layer 152 and the inner layer 154. The interlining 156 is not visible in FIG. 1, but can be seen in FIG. 2.

FIG. 2 is a schematic plan view diagram of an internal structure of the pet garment of FIG. 1. The outer layer 152, inner layer 154 and the interlining 156 all generally have the same shape. With reference to FIGS. 1 and 2, the garment body has two foreleg sleeve openings 111a and 111b, a collar edge 158, a distal edge 160, and at least first and second dorsal edges 162, 164. The dorsal edges 162, 164 are configured to be fastened to each other about the back of a pet, such that the collar edge and distal edge extends around the pet when the first and second dorsal edges 162, 164 are fastened, as shown in FIG. 1. FIG. 2 shows the garment with the inner layer 154 removed, and splayed out flat with the dorsal edges 162, 164 unconnected.

In this embodiment, the pet harness 100 includes a fastener arrangement 112 in the form of a known zipper arrangement that includes a zipper 166, a first tape 168 coupled to or near, or formed as, the first dorsal edge 162, and a second tape 170 coupled to or near, or formed as, the second dorsal edge 164. As is known in the art, each of the tapes 168, 170 includes complementary interlocking teeth that are coupled and decoupled by manipulation of the zipper 166.

With continued reference to FIGS. 1 and 2, the traction buckles 102a, 102b are located on two sides of the fastener arrangement 112, or otherwise proximate to the first dorsal edge 162, 164, respectively. The traction buckles 102a, 102b are each suitably rigid loops (e.g. a D-ring as shown) are configured to couple to suitable latch coupler 204 of an ordinary traction rope or pet leash 202. The traction buckles 102a, 102b are each coupled to opposite ends of the traction belt 121. The traction belt 121 is configured to extend around the pet, not shown, from below when the first and second dorsal edges 162, 164 are fastened such that the garment body 101 extends around the pet with two legs of the pet extending through the foreleg sleeve openings 111a, 111b. In some embodiments, at least a portion of the traction belt 121 is integrally sewn to the garment body 101. As shown in FIG. 2, some or all of the traction belt 121 may be sewn to the interlining 156. However, in embodiments without the interlining, some or all of the traction belt 121 may be sewn to either of the layers 152, 154. In some embodiments, at least another portion of the traction belt is movably disposed in the interlining 156 of the garment body 101.

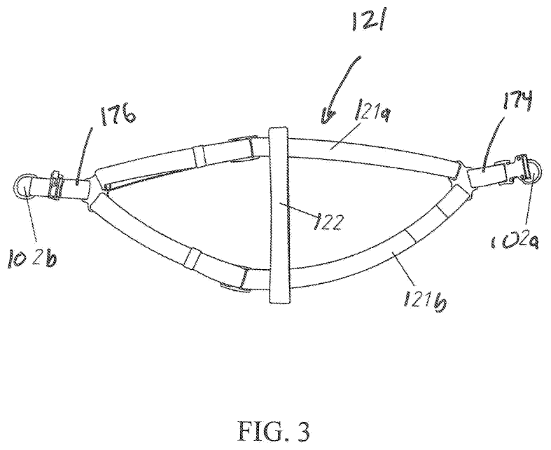

FIG. 3 shows a top plan view of the traction belt 121 and the traction bucklers 102 apart from the garment body 101. With reference to FIGS. 2 and 3, the traction belt comprises a first portion 121a, a second portion 121b, a first buckle webbing 174, a second buckle webbing 176, and a connection belt 122. The first portion 121a is located between the sleeve openings 111a, 111b and the collar edge 158. The second portion 121b is located between the sleeve openings 111a, 111b and the distal edge 160. The first buckle webbing 174 is coupled to the first traction buckle 102a and to a first end of each of the first portion 121a and the second portion 121b. The second buckle webbing 176 is coupled to the second traction buckle 102b and to a second end of each of the first portion 121a and the second portion 121b.

The first portion 121a is preferably webbing of flat structure, and extends from the first buckle webbing 174 to the second buckle webbing 176 in a slightly curved manner. As shown in FIG. 2, when the garment body 101 is laid flat, the first buckle webbing 174 and second buckle webbing 176 are aligned in the frontward-rearward (i.e. head-to-tail direction) close to the rearward edge of the sleeve openings 111a, 111b. Accordingly, the second portion 121b extends in a curved manner from the first buckle webbing 174 to the second buckle webbing 176 around the sleeve openings 111a, 111b, or in other words, rearwardly from the first buckle webbing 174 and around the rearward edges of the sleeve openings 111a, 111b, and back frontward to the second buckle webbing 176.

In this embodiment, the connecting belt 122 is also preferably flat webbing, and extends in the rearward-frontward direction between and connected to the first portion 121a and the second portion 121b of the traction belt 121.

When in use, what is needed is only to put the garment body 101 on a pet dog, for example, and connect the traction rope coupler ______ to the traction buckles 102. The garment body 101 is wrapped around the back of the dog, and then the fastener ______ is used to couple the first dorsal edge 162 to the second dorsal edge 164. The wearing operation is simple and convenient. Force of the traction buckles 102 is dispersed through the traction belt 121, which inhibits undesirable deformation of the garment body 101, and provide protection from tearing and breaking due to puffing. Thus, the structure improves reliability, safety, and comfort. In addition, the traction belt 121 is preferably disposed on the garment body 101. The one-piece structure does not need to be worn separately, which can improve wearing comfort and does not affect appearance of the garment body 101.

As discussed above, a preferable implementation between the traction belt 121 and the garment body 101 is that the traction belt 121 is integrally sewn on the garment body 101. Still further, the traction belt 121 is integrally sewn in interlining 156 of the garment body 101. In the foregoing embodiment, the traction belt 121 is fixed on the garment body 101, which can prevent the traction belt from loosening and shifting. The traction belt 121 sewn in the interlining 156 of the garment body 101 further improves the wearing comfort.

Another preferable implementation is that, the traction belt 121 is at least partially movably disposed in the interlining of the garment body 101. In the foregoing embodiment, the comfort is ensured, and the garment body 101 is not affected when the traction belt 121 is being pulled, which can avoid destroying the garment body 101.

The specific arrangement of the first portion 121a and the second portion 121b, as well as the connecting belt 122, as webbings of flat structure, disperses forces evenly around the forelegs of the pet dog. In addition, the webbings of flat structure reduce the tightening feeling, and can further improve the comfort and reliability during traction.

The above description is not intended to limit the technical scope of the present disclosure. Therefore, any amend, equivalent change, and modification made to the above embodiments according to the technical essence of the present disclosure still fall within the scope of the technical solutions of the present disclosure.

What is claimed is:

1. A pet garment structure, comprising:
a garment body having two foreleg sleeve openings, a collar edge, a distal edge, and at least first and second dorsal edges configured to be fastened to each other about the back of a pet, such that the collar edge and distal edge extends around the pet when the first and second dorsal edges are fastened;
at least a pair of traction buckles located proximate the first and second dorsal edges and configured to connect to a traction rope, wherein the traction buckles are connected by a traction belt configured to extend around the pet from below when the first and second dorsal edges are fastened such that the garment body extends around the pet with two legs of the pet extending through the foreleg sleeve openings, wherein at least a portion of the traction belt integrally sewn to the garment body.

2. The pet garment structure according to claim 2, wherein the traction belt is integrally sewn on an interlining of the garment body.

3. The pet garment structure according to claim 1, wherein at least a second portion of the traction belt is movably disposed in interlining of the garment body.

4. The pet garment structure according to claim 1, wherein the traction belt comprises a first portion located between the sleeve openings and the collar edge, and a second portion located between the sleeve openings and the distal edge.

5. The pet garment structure according to claim 4, further comprising a connecting belt extending between and connected to the first portion and the second portion of the traction belt.

6. The pet garment structure according to claim 5, wherein the traction belt and the connecting belt are webbings of flat structure.

7. The pet garment structure according to claim 1, wherein at least a portion of the traction belt comprises a webbing of flat structure.

8. The pet garment structure according to claim 1, further comprising a zipper operably coupled to fasten the first dorsal edge to the second dorsal edge.

9. The pet garment structure according to claim 1, wherein when the first and second dorsal ends are fastened, the traction buckles are disposed at a location that is intermediate a forward edge of the foreleg sleeve openings and a rearward edge of the foreleg sleeve openings.

10. The pet garment structure of claim 1, wherein:
the traction belt comprises a first portion located between the sleeve openings and the collar edge, a second portion located between the sleeve openings and the distal edge, a first buckle webbing coupled to a first traction buckle and to each of the first portion and the second portion, and a second buckle webbing coupled to a second traction buckle and to each of the first portion and the second portion; and
the second portion extends in a curved manner from the first buckle to the second buckle around the sleeve openings.

11. A pet garment structure, comprising:
a garment body having two foreleg sleeve openings, a collar edge, a distal edge, and at least first and second dorsal edges configured to be fastened to each other about the back of a pet, such that the collar edge and distal edge extends around the dog when the first and second dorsal edges are fastened;
at least a pair of traction buckles located proximate the first and second dorsal edges and configured to connect to a traction rope, wherein the traction buckles are configured to extend around the pet from below when the first and second dorsal edges are fastened such that the garment body extends around the pet with two legs of the pet extending through the foreleg sleeve openings; and
wherein when the first and second dorsal ends are fastened, the traction buckles are disposed at a location that is intermediate a forward edge of the foreleg sleeve openings and a rearward edge of the foreleg sleeve openings.

12. The pet garment structure of claim 11, wherein:
the traction belt comprises a first portion located between the sleeve openings and the collar edge, a second portion located between the sleeve openings and the distal edge, a first buckle webbing coupled to a first traction buckle and to each of the first portion and the second portion, and a second buckle webbing coupled to a second traction buckle and to each of the first portion and the second portion; and
the second portion extends in a curved manner from the first buckle to the second buckle around the sleeve openings.

13. The pet garment structure according to claim 12, further comprising a connecting belt extending between and connected to the first portion and the second portion of the traction belt.

14. The pet garment structure according to claim 13, wherein the traction belt and the connecting belt are webbings of flat structure.

15. The pet garment structure according to claim 11, wherein at least a portion of the traction belt comprises a webbing of flat structure.
